(19) United States
(12) Patent Application Publication
(10) Pub. No.: US 2026/0248159 A1
(43) Pub. Date: Aug. 27, 2026

(54) Zero or Reduced Calorie Sweetened Beverages Containing a High Potency Sweetener, Rare Sugar, and Hydrocolloid

(71) Applicant: Corn Products Development, Inc., Westchester, IL (US)

(72) Inventor: Kasi SUNDARESAN, Bridgewater, NJ (US)

(21) Appl. No.: 18/995,403

(22) PCT Filed: Jul. 25, 2023
(86) PCT No.: PCT/US2023/070900

§ 371 Date: Jan. 16, 2025

Related U.S. Application Data
(60) Provisional application No. 63/394,733, filed on Aug. 3, 2022.

(51) Int. Cl. A23L 2/60; A23F 3/16; A23F 5/24; A23L 27/30; A23L 29/231; A23L 29/269

(52) U.S. Cl. CPC A23L 2/60; A23F 3/16; A23F 5/243; A23L 27/36; A23L 29/231; A23L 29/27

(57) ABSTRACT

The present technology provides a beverage composition that includes about 0.005 wt % to about 0.06 wt % of a high potency sweetener, about 0.005 wt % to about 0.75 wt % of a hydrocolloid, and about 1 wt % to about 5 wt % of a rare sugar. The beverage composition may be a zero or reduced calorie sweetened beverage composition, which mimics taste normally delivered from sucrose.

The present technology is directed to zero or reduced calorie beverage compositions.

Sweeteners commonly provide a crucial role in our selection and enjoyment of foodstuff. Sucrose (i.e., table sugar) is the established gold standard among sweeteners, because it provides the desired onset (i.e., appearance time) and decay of sweetness (i.e., extinction time). Along with sweetness, sucrose also provides mouthfeel and optimal flavor release. However, sucrose contributes calories to the foodstuff in which it is added. Every gram of sucrose has about 4 calories. Commonly, a 12-ounce serving of a sweetened beverage includes 30 grams or more of sucrose correlating to 120 calories or more. There is a need to reduce caloric intake, because high calorie diets are associated with obesity, metabolic syndrome, cardiovascular disease, and many other health problems. One way to reduce calorie intake is replace high calorie beverages with zero or reduced calorie beverages. However, many zero or reduced calorie beverages exhibit prolonged sweetness, sweetness adaption, and diminished mouth-feel.

The present technology provides a beverage composition that overcomes problems in the prior art as described. In any embodiment this specification discloses a beverage composition that includes about 0.005 wt % to about 0.06 wt % of a high potency sweetener, about 0.005 wt % to about 0.75 wt % of a hydrocolloid, and about 1 wt % to about 5 wt % of a rare sugar. In any embodiment, the beverage composition may be a zero or reduced calorie sweetened beverage composition, which mimics the sugar-like taste normally delivered from sucrose.

In any embodiment, the rare sugar and the hydrocolloid may have a weight ratio of at least about 5:1. In any embodiment, the rare sugar and the hydrocolloid may have a weight ratio of at least about 10:1, at least about 20:1 at least about 30:1, at least about 40:1, at least about 50:1, at least about 60:1, at least about 70:1, at least about 80:1, at least about 90:1, or at least about 100:1.

In any embodiment, the high potency sweetener may be a natural sweetener. In any embodiment, the natural sweetener may be derived from Stevia rebaudiana and/or Siraitia grosvenorii. In any embodiment, the natural sweetener may be derived from Stevia rebaudiana. In any embodiment, the high potency sweetener may include stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside P, rebaudioside Q, steviolbioside, dulcoside A, rubusoside, siamenoside, monatin, curculin, glycyrrhizic acid, neohesperidin, dihydrochalcone, glycyrrhizin, glycyphyllin, phloridzin, trilobatin, phyllodulcin, brazzein, hernandulcin, osladin, polypodoside A, baiyunoside, pterocaryoside A and B, mukurozioside, thaumatin, monellin, mabinlins I, mabinlins II, phlomisoside I, periandrin I, abrusoside A, cyclocarioside I, mogroside IV, mogroside V, or a combination of two or more thereof. In any embodiment, the natural sweetener may be derived from Stevia rebaudiana. In any embodiment, the high potency sweetener may include stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside P, rebaudioside Q, steviolbioside, dulcoside A, or a combination of two or more thereof. In any embodiment, the high potency sweetener may include rebaudioside A, rebaudioside D, rebaudioside M, or a combination of two or more thereof.

In any embodiment, the composition may include about 0.01 wt % to about 0.06 wt % of the high potency sweetener. In any embodiment, the composition may include about 0.02 wt % to about 0.06 wt % or about 0.03 wt % to about 0.06 wt % of the high potency sweetener.

In any embodiment, the hydrocolloid may include pectin, gum, high molecular weight carboxymethylcellulose, alginate, oligosaccharide fiber, or a combination of two or more thereof. In any embodiment, the hydrocolloid may include pectin, gum acacia, gellan gum, xanthan gum, guar gum, locust bean gum, cassia gum, high molecular weight carboxymethylcellulose, carrageenan, alginate, oligosaccharide fiber, or a combination of two or more thereof. In any embodiment, the hydrocolloid may include pectin, gellan gum, xanthan gum, guar gum, locust bean gum, cassia gum, high molecular weight carboxymethylcellulose, carrageenan, alginate, oligosaccharide fiber, or a combination of two or more thereof. In any embodiment, the hydrocolloid may include pectin, gum acacia, gellan gum, xanthum gum, guar gum, locust bean gum, cassia gum, high molecular weight carboxymethylcellulose, carrageenan, alginate, oligosaccharide fiber, or a combination of two or more thereof. In any embodiment, the hydrocolloid may include gum acacia, gellan gum, or a combination thereof. In some embodiments, the hydrocolloid may include about 0.2 wt % to about 0.6 wt % gum acacia, gellan gum, or a combination thereof. In any embodiment, the hydrocolloid may include pectin. In some embodiments, the hydrocolloid may include about 0.02 wt % to about 0.1 wt % pectin. In any embodiment, the hydrocolloid may include xanthan gum. In some embodiments, the hydrocolloid may include about 0.1 wt % to about 0.5 wt % xanthan gum. In any embodiment, the composition may not simultaneously include both pectin and a gum. In any embodiment, the composition may include one hydrocolloid.

In any embodiment, the composition may include about 0.01 wt % to about 0.7 wt % of the hydrocolloid. In any embodiment, the composition may include about 0.02 wt % to about 0.6 wt %, about 0.02 wt % to about 0.5 wt %, about 0.02 wt % to about 0.3 wt %, about 0.02 wt % to about 0.2 wt %, about 0.02 wt % to about 0.1 wt %, about 0.05 wt % to about 0.6 wt %, about 0.1 wt % to about 0.6 wt %, about 0.2 wt % to about 0.6 wt %, or about 0.1 wt % to about 0.5 wt % of the hydrocolloid.

In any embodiment, the rare sugar may include allulose, tagatose, sorbose, apiose, allose, altrose, melezitose, L-ribose, L-fucose, L-arabinose, D-turanose, D-leucrose, or a combination of two or more thereof. In any embodiment, rare sugar may include allulose, tagatose, sorbose, apiose, allose, altrose, melezitose, or a combination of two or more thereof. In any embodiment, the rare sugar may include allulose, tagatose, sorbose, apiose, allose, altrose, melezitose, or a combination of two or more thereof. In any embodiment, the rare sugar may include allulose.

In any embodiment, the composition may include about 1.5 wt % to 4.5 wt % of the rare sugar. In any embodiment, the composition may include about 2 wt % to 4 wt % of the rare sugar.

In any embodiment, the composition may include steviol, erythritol, xylitol, iditol, or a combination of two or more thereof in addition to the high potency sweetener.

In any embodiment, the composition may include water. In any embodiment, the composition may include at least about 25 wt % water. In any embodiment, the composition may include at least about 50 wt % water. In any embodiment, the composition may include about 50 wt % to about 99 wt % water. In any embodiment, the composition may include about 60 wt % to about 98.9 wt %, about 70 wt % to about 98.9 wt %, about 80 wt % to about 98.9 wt %, about 90 wt % to about 98.9 wt % water.

In any embodiment, the high potency sweetener, the hydrocolloid, and/or the rare sugar do not exhibit substantial viscosity modification. In any embodiment, the high potency sweetener, the hydrocolloid, and the rare sugar do not exhibit substantial viscosity modification. In any embodiment, the high potency sweetener, the hydrocolloid, and the rare sugar exhibit viscosity modification similar to that of sucrose.

In any embodiment, the composition may be in the form of a liquid, syrup, gel, or solid (e.g., powder). In some embodiments, the composition may be in the form of a liquid. In some embodiments, the composition may have a viscosity less than about 10 mPas. In any embodiment, the composition may have a viscosity less than about 8 mPas, less than about 5 mPas, less than about 3 mPas, less than about 2 mPas, less than about 1 mPas, or less than about 0.5 mPas,

In any embodiment, the composition may be a zero calorie or reduced calorie beverage composition. In any embodiment, the composition may be a zero calorie beverage composition. In some embodiments, the composition may be a carbonated beverage composition. In other embodiments, the composition may be a non-carbonated beverage composition.

In any embodiment, the composition may exhibit substantially the same taste or the same taste as an equivalent full-calorie beverage composition. In any embodiment, the composition may exhibit substantially the same appearance time and extension time or the same appearance time and extension time as an equivalent full-calorie beverage composition. In any embodiment, the composition may exhibit substantially the same sweetness adaption or the same sweetness adaption as an equivalent full-calorie beverage composition. In any embodiment, the composition may exhibit sweetness and mouthfeel that are substantially the same or the same as an equivalent full-calorie beverage composition.

In any embodiment, the composition may include rebaudioside A, rebaudioside D, rebaudioside M, or a combination of two or more thereof; pectin or gum acacia; and allulose. In any embodiment, the composition may include about 0.005 wt % to about 0.06 wt % rebaudioside A, rebaudioside D, rebaudioside M, or a combination of two or more thereof; about 0.005 wt % to about 0.75 wt % pectin or gum acacia; and about 1 wt % to about 5 wt % allulose. In any embodiment, the composition may include about 0.01 wt % to about 0.05 wt % rebaudioside A, rebaudioside D, rebaudioside M, or a combination of two or more thereof; about 0.01 wt % to about 0.2 wt % pectin or about 0.05 wt % to about 0.7 wt % gum acacia; and about 1.5 wt % to about 4.5 wt % allulose. In any embodiment, the composition may include about 0.02 wt % to about 0.04 wt % rebaudioside A, rebaudioside D, rebaudioside M, or a combination of two or more thereof; about 0.02 wt % to about 0.08 wt % pectin or about 0.1 wt % to about 0.6 wt % gum acacia; and about 2.5 wt % to about 4.5 wt % allulose.

The examples herein are provided to illustrate advantages of the present technology and to further assist a person of ordinary skill in the art with preparing or using the compositions of the present technology. The examples herein are also presented in order to more fully illustrate the preferred aspects of the present technology. The examples should in no way be construed as limiting the scope of the present technology, as defined by the appended claims. The examples can include or incorporate any of the variations, aspects or aspects of the present technology described above. The variations, aspects or aspects described above may also further each include or incorporate the variations of any or all other variations, aspects or aspects of the present technology.

Following are definitions of select terms useful to understand the technology disclosed in this specification and other guidance for interpreting this specification.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, “mouthfeel” refers to the tactile aspects of texture perception during consumption of a foodstuff from the time at which the solid, semi-solid, or liquid foodstuff is placed in the mouth until it is swallowed. Mouthfeel is perceived by the lining of the mouth, including the tongue, gums, and teeth.

As used herein, “foodstuff” refers to a substance suitable for consumption including solid, semi-solid, or liquid food and/or beverage.

As used herein, “beverage” refers to a drinkable substance. Beverages include, but are not limited to the following: carbonated and non-carbonated, alcoholic and non-alcoholic drinks including but not limited to carbonated water, flavored water, carbonated flavored water, drinks containing juice (juice derived from any fruit or any combination of fruits, juice derived from any vegetable or any combination of vegetables) or nectar, milk obtained from animals, milk product derived from soy, rice, coconut or other plant material, sports drinks, vitamin enhanced sports drinks, high electrolyte sports drinks, highly caffeinated high energy drinks, coffee, decaffeinated coffee, tea, tea derived from fruit products, tea derived from herb products, decaffeinated tea, wine, champagne, malt liquor, rum, gin, vodka, other hard liquors, beer, reduced calorie beer-type beverages, non-alcoholic beer, and other beer-type beverages obtained from a cereal solution such as beer, ale, stout, lager, porter, low alcoholic beer, alcohol-free beer, kvass, rye-bread beer, shandy, malt drinks and the like. Cereal in this context refers to grains commonly used to make the beverages listed above and other similar beverages. Beverage excludes 100% juice based-beverages.

As used herein, “substantially free” refers to less than about 2 wt % of the specified component based on the total weight of the composition. In any embodiment, the composition may include less than about 1 wt %, less than about 0.5 wt %, or less than about 0.1 wt %.

As used herein, “appearance time” and “extension time” refer to the changes in perception of sweetness over time. Every sweetener exhibits a characteristic “appearance time” and “extension time.” In contrast to sucrose, most high-potency sweeteners display undesirable prolonged extension time (i.e., lingering). Generally, the detected sweetener spikes to a maximal response level, then tapers off over time. The longer the taper, the greater the detected sweetness linger following initial ingestion or expectoration.

As used herein, “sweetness adaption” refers to reduced responsivity to a taste stimulus when the stimulus is repeatedly applied to the tongue. The repeated applying to the tongue may be include short time interval interruptions. Herein, sweetness adaption was tested through a sip-and-swallow method designed to simulate normal drinking to determine adaptation to sweetness over time. The sip-and-swallow method includes a subject drinking by mouth at least two small amounts (e.g., about 200 mL to about 400 mL) of the composition within a 15 minute period of time. In any embodiment, the subject may drink 2 to 6 small amounts of the composition.

As used herein, “equivalent full-calorie beverage composition” or “control beverage composition” refers to a sweetened beverage composition that is sweetened by sucrose or high fructose corn syrup. A control beverage composition has all ingredients the same except the high potency sweetener, the hydrocolloid, and the rare sugar as disclosed herein are replaced by about 9 wt % sucrose composition or high fructose corn syrup (“HFCS”) equivalent to about 9% sucrose (e.g., HFCS 42 (71 solids) is 12.68% and HFCS 55 (77 solids) is 11.68%).

As used herein, “reduced calorie beverage composition” refers to a sweetened beverage composition that has at least about 25% less calories than an equivalent full-calorie beverage composition. In any embodiment, the reduced calorie beverage composition may have at least about 50% less calories than an equivalent full-calorie beverage composition. In any embodiment, the reduced calorie beverage composition may have at least about 65% less calories than an equivalent full-calorie beverage composition. In any embodiment, the reduced calorie beverage composition may have at least about 75% less calories than an equivalent full-calorie beverage composition. In any embodiment, the reduced calorie beverage composition may have at least about 90% less calories than an equivalent full-calorie beverage composition. In any embodiment, the reduced calorie beverage composition may have a calorie reduction of about 50% to about 100% compared to an equivalent full-calorie beverage composition. In any embodiment, the reduced calorie beverage composition may have a calorie reduction of about 65% to about 100% compared to an equivalent full-calorie beverage composition. In any embodiment, the reduced calorie beverage composition may have a calorie reduction of about 75% to about 100% compared to an equivalent full-calorie beverage composition.

As used herein, “high potency” or “high intensity” sweetener refers to a sweetener that is sweeter than sucrose, but contributes minimal or no calories when added to foodstuff. In any embodiment, high potency or high intensity sweeteners may be at least about 2-times sweeter than sucrose. In any embodiment, “high potency” or “high intensity” sweeteners may be at about 10-times, at least about 25-times, at about 50-times, at least about 75-times, at least about 100-times, about 125-times, at least about 150-times, at about 175-times, or at least about 200-times sweeter than sucrose. In any embodiment, high potency or high intensity sweeteners may include, but not limited to, those derived from Stevia (including S. eupatoria, S. ovata, S plummerae, S. rebaudiana, S. salicifolia, S. serrata, and/or S. rebaudiana) saccharin, aspartame, acesulfame potassium, sucralose, neotame, advantame, those derived from Siraitia grosvenorii, or a combination of two or more thereof.

As used herein, “rare sugar” refers to a sugar that occurs in limited quantities in nature. Rare sugars may be produced commercially using microbial enzymes. In any embodiment, rare sugars may include, but are not limited to, allulose, tagatose, sorbose, apiose, allose, altrose, melezitose, L-ribose, L-fucose, L-arabinose, D-turanose, D-leucrose, or a combination of two or more thereof. In any embodiment, rare sugar may include allulose, tagatose, sorbose, apiose, allose, altrose, melezitose, or a combination of two or more thereof. In any embodiment, rare sugar may include allulose.

As used herein, “hydrocolloid” refers to foodstuff additive that may texture through thickening or gel formation. The amount of thickening or gel formation depends on the hydrocolloids chemical, physical and functional properties. Hydrocolloids as used herein may include any of those provided in D. Saha, et al. “Hydrocolloids as thickening and gelling agents in food: a critical review.” J. Food Sci. Technol. 47, 587-597 (2010), which is herein incorporated by reference. In any embodiment, hydrocolloids may include water-soluble polysaccharides. In any embodiment, hydrocolloids may include, but not limited to, pectin, gum, high molecular weight carboxymethylcellulose, alginate, oligosaccharide fiber (e.g., short-chain fructo-oligosaccharide, dextrin, or inulin), or a combination of two or more thereof.

As used herein, “gum” refers to a water-soluble polysaccharide. Non-limiting examples of the gum include, but are not limited to, gum acacia, cellulose gum, tragacanth gum, locust bean gum, karaya gum, ghatti gum, tara gum, konjac gum, xanthan gum, curdlan gum, gellan gum, algin gum, and carrageenan gum. In any embodiment, gum may include cellulose gum, carrageenan gum, and/or xanthan gum. In any embodiment, gum may include xanthan gum. In any embodiment, gum may include gum acacia.

As used herein, “informal taste evaluation” refers to core scientific team (about 10 members) evaluation tastings with composition at 4° C. using a comparative 100 point line scale.

The technology disclosed in this specification can be better understood with reference to the following aspects, which are provided for illustrative purposes only and are not intended to limit the full scope the disclosed technology.

1. A beverage composition comprising: about 0.005 wt % to about 0.06 wt % of a high potency sweetener; about 0.005 wt % to about 0.75 wt % of a hydrocolloid; and about 1 wt % to 5 about wt % of a rare sugar.

2. The composition of embodiment 1, wherein the composition comprises about 0.03 wt % to about 0.06 wt % of the high potency sweetener.

3. The composition of embodiment 1 or 2, wherein the high potency sweetener is a natural sweetener.

4. The composition of embodiment 3, wherein the natural sweetener is derived from Stevia rebaudiana.

5. The composition of embodiment 4, wherein the natural sweetener is selected from stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside P, rebaudioside Q, steviolbioside, dulcoside A, and combinations of two or more thereof.

6. The composition of any one of embodiments 1-5, wherein the hydrocolloid is selected from pectin, gum, high molecular weight carboxymethylcellulose, alginate, oligosaccharide fiber, and combinations of two or more thereof.

7. The composition of embodiment 6, wherein the hydrocolloid is selected from pectin, gum acacia, gellan gum, xanthum gum, guar gum, locust bean gum, cassia gum, high molecular weight carboxymethylcellulose, carrageenan, alginate, and oligosaccharide fiber, and combinations of two or more thereof.

8. The composition of any one of embodiments 1-7, wherein the hydrocolloid consists of one hydrocolloid.

9. The composition of any one of embodiments 1-8, wherein the composition comprises about 0.02 wt % to about 0.6 wt % of the hydrocolloid.

10. The composition of any one of embodiments 1-9, wherein the hydrocolloid comprises pectin.

11. The composition of embodiment 10, wherein the composition comprises about 0.02 wt % to about 0.1 wt % of the hydrocolloid.

12. The composition of any one of embodiments 1-9, wherein the hydrocolloid comprises xanthum gum.

13. The composition of embodiment 12, wherein the composition comprises about 0.1 wt % to about 0.5 wt % of the hydrocolloid.

14. The composition of any one of embodiments 1-13, wherein the hydrocolloid does not include both pectin and a gum.

15. The composition of any one of embodiments 1-14, wherein the composition comprises about 2 wt % to 4 wt % of the rare sugar.

16. The composition of any one of embodiments 1-15, wherein the rare sugar is selected from allulose, tagatose, sorbose, apiose, allose, altrose, melezitose, and combinations of two or more thereof.

17. The composition of embodiment 16, wherein the rare sugar comprises allulose.

18. The composition of any one of embodiments 1-17, wherein the rare sugar and the hydrocolloid have a weight ratio at least 5:1.

19. The composition of embodiment 18, wherein the rare sugar and the hydrocolloid have a weight ratio of at least 50:1.

20. The composition of any one of embodiments 1-19 furthering comprising steviol, erythritol, xylitol, iditol, or combinations of two or more thereof.

21. The composition of any one of embodiments 1-20 further comprising at least about 50 wt % water.

22. The composition of any one of embodiments 1-21, wherein the composition is zero calorie or reduced calorie.

23. The composition of embodiment 22, wherein the composition is zero calorie.

24. The composition of any one of embodiments 1-23, wherein the high potency sweetener, the hydrocolloid, and the rare sugar exhibit substantially the same viscosity modification as sucrose in an equivalent full-calorie beverage composition.

25. The composition of any one of embodiments 1-24, wherein the composition exhibits substantially the same appearance time and extension time, sweetness adaption, and/or mouthfeel as an equivalent full-calorie beverage composition.

26. The composition of any one of embodiments 1-34, wherein the composition has a viscosity less than about 10 mPas.

27. The composition of embodiment 26, wherein the composition has a viscosity less than about 3 mPas.

28. The composition of any one of embodiments 1-27, wherein the high potency sweetener comprises rebaudioside A, rebaudioside D, rebaudioside M, and combinations of two or more thereof; the hydrocolloid comprises pectin or gum acacia; and the rare sugar comprises allulose.

29. The composition of any one of embodiments 1-28, wherein the composition is a carbonated composition.

While certain embodiments have been illustrated and described, a person with ordinary skill in the art, after reading the foregoing specification, can effect changes, substitutions of equivalents and other types of alterations to the compounds of the present technology or salts, pharmaceutical compositions, derivatives, prodrugs, metabolites, tautomers or racemic mixtures thereof as set forth herein. Each aspect and embodiment described above can also have included or incorporated therewith such variations or aspects as disclosed in regard to any or all of the other aspects and embodiments.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, reagents, compounds, compositions, labeled compounds or biological systems, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology disclosed in this specification can be better understood with reference to the following examples which are for illustrative purposes and are not intended to limit the full scope of technology.

### EXAMPLE 1. TEA BEVERAGE COMPOSITIONS

Several beverage compositions were prepared by mixing the ingredients with an overhead mixer into an unsweetened tea solution at room temperature for about 5 minutes to ensure uniform distribution to provide the compositions in Tables 1a and 1b. Each composition was then assessed by informal taste evaluation (Tables 1a and 1b). It was determined the combination of a high potency sweetener, hydrocolloid, and rare sugar provided the most similar sweet taste, linger, and mouthfeel as the control composition.

TABLE 1
Tea Beverage Compositions

| | | | | Comp. | Comp. | Comp. |
|---|---|---|---|---|---|---|
| | Control | Comp. 1 | Comp. 2 | 3 | 4 | 5 |
| Ingredients | (wt %) | (wt %) | (wt %) | (wt %) | (wt %) | (wt %) |
| Sucrose | 9 | — | — | — | — | — |
| High potency | — | 0.0575 | 0.0575 | 0.0575 | 0.0575 | 0.0575 |
| sweetener | | | | | | |
| (Reb M, 95%) | | | | | | |
| Hydrocolloid | — | — | 0.0375 (Pectin) | 0.075 (Pectin) | 0.25 (Gum | 0.5 (Gum |
| | | | | | acacia) | acacia) |
| Rare sugar | — | — | — | — | — | — |
| (Allulose, | | | | | | |
| 74.51%) | | | | | | |
| Tea | 91 | 91 | 91 | 91 | 91 | 91 |
| Water | | 8.9425 | 8.905 | 8.8675 | 8.6925 | 8.4425 |
| Total | 100 | 100 | 100 | 100 | 100 | 100 |
| Evaluation | Sweet, | Slightly | Sweetness | Sweetness | Alternate | Muted or |
| | standard | delayed | similar to | linger, | tea taste | off tea |
| | tea notes, | sweetness, | control, | muted tea | (possible | notes, |
| | no | sweeter | mouthfeel | notes, | muted), | taste gum |
| | aftertaste | then | and tea | slight | taste gum | acacia, |
| | | control, | taste | pectin | acacia, | more |
| | | slight | slightly | taste, | slightly | viscous |
| | | licorice | different | slightly | more | that |
| | | notes, | than | more | viscous | control. |
| | | some | control | viscous | than | |
| | | astringency | | than | control | |
| | | | | control | | |

| | Comp. | Comp. | | | |
|---|---|---|---|---|---|
| | 6 | 7 | Comp. 8 | Comp. 9 | Comp. 10 |
| Ingredients | (wt %) | (wt %) | (wt %) | (wt %) | (wt %) |
| Sucrose | — | — | — | — | — |
| High potency | 0.035 | 0.035 | 0.035 | 0.035 | 0.035 |
| sweetener | | | | | |
| (Reb M, 95%) | | | | | |
| Hydrocolloid | — | 0.0375 (Pectin) | 0.075 (Pectin) | 0.25 (Gum | 0.5 (Gum |
| | | | | acacia) | acacia) |
| Rare sugar | 4.7 | 4.7 | 4.7 | 4.7 | 4.7 |
| (Allulose, | | | | | |
| 74.51%) | | | | | |
| Tea | 91 | 91 | 91 | 91 | 91 |
| Water | 4.265 | 4.2275 | 4.19 | 4.015 | 3.765 |
| Total | 100 | 100 | 100 | 100 | 100 |
| Evaluation | Slightly | Similar | Similar | Similar | Similar |
| | sweeter | sweetness | sweetness | sweetness | sweetness |
| | with less | and | to control, | to control, | to control, |
| | mouthfeel, | mouthfeel | slightly | covers tea | different tea |
| | no | to control, | higher | notes, taste | notes, taste |
| | sweetness | some | viscosity | gum acacia | gum acacia, |
| | linger, | upfront | | | slightly |
| | slightly | sweetness | | | higher |
| | different tea | and linger, | | | viscosity |
| | notes | standard tea | | | |
| | | notes, most | | | |
| | | similar to | | | |
| | | control | | | |

### EXAMPLE 2. COFFEE CREAMER COMPOSITIONS

The full sugar and 65% reduced sugar coffee compositions in Table 2 were prepared by adding the disodium phosphate, sodium citrate, and sodium chloride to water and mixing for 5 minutes. Next, ENLITEN® Fusion 7200 was added and dissolved into the mixture followed by the addition of Pre-Hydrated Pectin 1694. The mixture was allowed to hydrate for about 10 minutes followed by the addition of ASTRAEA® Liquid Allulose and mixing to provide a uniform solution. The instant coffee and a sugar (full or 65%) were then added and dissolved into the mixture. Next, half and half was added and mixing was conducted until a uniform composition was provided. The composition was then batch pasteurize at about 82° C. for 5 minutes followed by homogenizing using a Ross mixer (5500 rpm for 30 seconds). The composition was poured into sanitized bottles, which were cooled immediately on ice. The composition containing bottles were stored in a refrigerator until evaluation.

TABLE 2
Coffee Creamer Compositions

| | Full Sugar | 65% Reduced Sugar |
|---|---|---|
| Ingredients | (wt %) | (wt %) |
| Water | 68.850 | 70.8925 |
| Half & Half | 20.00 | 20.00 |
| Instant Coffee (Nescafe Clasico - | 0.55 | 0.55 |
| Dark Roast) | | |
| Disodium Phosphate | 0.10 | 0.10 |
| Sodium Citrate | 0.05 | 0.05 |
| Sodium Chloride | 0.05 | 0.05 |
| Sucrose | 10.40 | 3.60 |
| 37% Reb A/60% Reb D | — | 0.0225 |
| (ENLITEN ® Fusion 7200) | | |
| Pectin | — | 0.025 |
| (TIC Pre-Hydrated Pectin 1694) | | |
| Allulose (74.5%) | — | 4.71 |
| Total | 100 | 100 |

Each composition was assessed by informal taste evaluation. The 65% reduced sugar composition provided desirable sweet taste including nice rounded sweetness, no noticeable off notes, and mouthfeel that was comparable to the full sugar control.

### EXAMPLE 3. FLAVORED COFFEE SYRUP COMPOSITIONS

The full sugar and sugar-free coffee syrup compositions in Table 3 were prepared by dry blending potassium sorbate, citric acid, and (if present) xanthan gum. In a separate container, water mixed (strong vortex) and heated to about 60° C. The dry blend was slowly added and mixing was continued until a uniform mixture was provided (about 10-20 minutes). The stevia and allulose were then mixed into the sugar-free composition until a homogenous composition was provided.

TABLE 3
Flavored Coffee Syrup Compositions

| | Full Sugar | Sugar-Free |
|---|---|---|
| Ingredients | (wt %) | (wt %) |
| Water | 50.93 | 51.54 |
| Potassium Sorbate | 0.03 | 0.03 |
| Citric Acid | 0.04 | 0.04 |
| Natural French Vanilla Flavor | 1.00 | 1.00 |
| Sucrose | 48.00 | — |
| 56% Reb A/40% Reb M | — | 0.15 |
| (ENLITEN ® Fusion 6400) | | |
| Xanthan Gum | — | 0.14 |
| (Pre-Hydrated Ticaxan Rapid Non- | | |
| GMO) | | |
| Allulose (74.5%) | — | 47.1 |
| Total | 100 | 100 |

Each composition was assessed by informal taste evaluation. The sugar-free composition provided desirable sweet taste, mouthfeel, and flavor delivery that was comparable to the full sugar control when each were reconstituted with hot coffee.

### EXAMPLE 4. PROTEIN SHAKE COMPOSITIONS

The full sugar and sugar-free protein shake compositions in Table 4 were prepared by dry blend VITESSENCE® 1803 Pea Protein Isolate, cocoa powder, (if present) ENLITEN® Fusion 9200, and TICALOID® Pro 181 AG. The dry blend was dissolved in water by mixing with a high shear. The sunflower oil, flavor, and (if present) ASTRAEA® Liquid Allulose, were then added and mixed into the composition until a uniform composition was provided. The composition was then heated to about 146° for 6 seconds followed by homogenization (2000 psi/500 psi). The composition was cooled (about 10° C.) and poured into sanitized bottles. The composition containing bottles were stored in a refrigerator until evaluation.

TABLE 4
Protein Shake Compositions

| | Full Sugar | Sugar-Free |
|---|---|---|
| Ingredients | (wt %) | (wt %) |
| Water | 82.45 | 83.7025 |
| Pea Protein Isolate | 8.00 | 8.00 |
| (VITESSENCE ™ 1803) | | |
| Cocoa Powder | 1.50 | 1.50 |
| Organic Sunflower Oil | 1.00 | 1.00 |
| Natural Vanilla Flavor | 0.75 | 0.75 |
| Sucrose | 6.00 | — |
| 28% Reb A/45% Reb D/24% Reb M | — | 0.0375 |
| (ENLITEN ® Fusion 9200) | | |
| Gum Acacia (TICALOID ® Pro 181 | 0.30 | 0.30 |
| AG) | | |
| Allulose (74.5%) | — | 4.71 |
| Total | 100 | 100 |

Each composition was assessed by informal taste evaluation. The sugar-free composition provided desirable sweet taste and mouthfeel with clean flavor delivery that was comparable to the full sugar control.

1. A beverage composition comprising:
about 0.005 wt % to about 0.06 wt % of a high potency sweetener;
about 0.005 wt % to about 0.75 wt % of a hydrocolloid; and
about 1 wt % to 5 about wt % of a rare sugar.

2. The composition of claim 1, wherein the composition comprises about 0.03 wt % to about 0.06 wt % of the high potency sweetener.

3. The composition of claim 1, wherein the high potency sweetener is a natural sweetener.

4. The composition of claim 1, wherein the natural sweetener is derived from Stevia rebaudiana.

5. The composition of claim 1, wherein the natural sweetener is selected from stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside P, rebaudioside Q, steviolbioside, dulcoside A, and combinations of two or more thereof.

6. The composition of claim 1, wherein the hydrocolloid is selected from pectin, gum, high molecular weight carboxymethylcellulose, alginate, oligosaccharide fiber, and combinations of two or more thereof.

7. The composition of claim 1, wherein the hydrocolloid is selected from pectin, gum acacia, gellan gum, xanthum gum, guar gum, locust bean gum, cassia gum, high molecular weight carboxymethylcellulose, carrageenan, alginate, and oligosaccharide fiber, and combinations of two or more thereof.

8. The composition of claim 1, wherein the hydrocolloid consists of one hydrocolloid.

9. The composition of claim 1, wherein the composition comprises about 0.02 wt % to about 0.6 wt % of the hydrocolloid.

10. The composition of claim 1, wherein the hydrocolloid comprises pectin.

11. The composition of claim 1, wherein the composition comprises about 0.02 wt % to about 0.1 wt % of the hydrocolloid.

12. The composition of claim 1, wherein the hydrocolloid comprises xanthum gum.

13. The composition of claim 1, wherein the composition comprises about 0.1 wt % to about 0.5 wt % of the hydrocolloid.

14. The composition of claim 1, wherein the hydrocolloid does not include both pectin and a gum.

15. The composition of claim 1, wherein the composition comprises about 2 wt % to 4 wt % of the rare sugar.

16. The composition of claim 1, wherein the rare sugar is selected from allulose, tagatose, sorbose, apiose, allose, altrose, melezitose, and combinations of two or more thereof.

17. The composition of claim 1, wherein the rare sugar comprises allulose.

18. The composition of claim 1, wherein the rare sugar and the hydrocolloid have a weight ratio at least 5:1.

19. The composition of claim 1, wherein the rare sugar and the hydrocolloid have a weight ratio of at least 50:1.

20. The composition of claim 1 furthering comprising steviol, erythritol, xylitol, iditol, or combinations of two or more thereof.

21-29. (canceled)
